(19) United States
(12) Patent Application Publication
(10) Pub. No.: US 2025/0310298 A1
(43) Pub. Date: Oct. 2, 2025

(54) METHODS, SYSTEMS, AND COMPUTER READABLE MEDIA FOR FORWARDING INTER-PUBLIC LAND MOBILE NETWORK (PLMN) SERVICE-BASED INTERFACE (SBI) REQUEST MESSAGES TO AVAILABLE PRODUCER SECURITY EDGE PROTECTION PROXIES (P-SEPPs)

(71) Applicant: Oracle International corporation, Redwood Shores, CA (US)

(72) Inventors: John Nirmal Mohan Raj, Bangalore (IN); Ashish Jyoti Dharma, New Delhi (IN); Sonia Kadyan, New Delhi (IN); Jay Rajput, Bangalore (IN)

(21) Appl. No.: 18/618,742

(22) Filed: Mar. 27, 2024

(51) Int. Cl. H04L 61/59; H04L 43/0811; H04L 61/4511; H04W 8/30; H04W 84/04

(52) U.S. Cl. CPC H04L 61/59; H04L 43/0811; H04L 61/4511; H04W 8/30; H04W 84/042

(57) ABSTRACT

A method for forwarding inter-PLMN SBI request messages to available P-SEPPs includes establishing, by a C-SEPP, connections with a plurality of P-SEPPs. The method further includes testing, by the C-SEPP, availability status of each of the P-SEPPs. The method further includes maintaining, by the C-SEPP and based on the testing, an indication of availability status of each of the P-SEPPs. The method further includes receiving, by the C-SEPP, an inter-PLMN SBI request message and determining, from the message, an FQDN. The method further includes resolving the FQDN into a DNS SRV record including target identifiers corresponding to the P-SEPPs. The method further includes selecting one of the target identifiers in the DNS SRV record corresponding to one of the P-SEPPs having an available status. The method further includes forwarding the message to the P-SEPP corresponding to the selected target identifier.

### TECHNICAL FIELD

The subject matter described herein relates to forwarding messages between networks. More particularly, the subject matter described herein relates to methods, systems, and computer readable media for forwarding inter-PLMN SBI request messages to available P-SEPPs.

### BACKGROUND

In 5G telecommunications networks, a network function that provides service is referred to as a producer NF or service producer. A network function that consumes services is referred to as a consumer NF or NF service consumer. A network function can be a producer NF, a consumer NF, or both, depending on whether the network function is consuming, producing, or consuming and producing services. The terms “producer NF” and “NF service producer” are used interchangeably herein. Similarly, the terms “consumer NF” and “NF service consumer” are used interchangeably herein.

A given producer NF may have many service endpoints, where a service endpoint is the point of contact for one or more NF instances hosted by the producer NF. The service endpoint is identified by a combination of Internet protocol (IP) address and port number or a fully qualified domain name (FQDN) that resolves to an IP address and port number on a network node that hosts a producer NF. An NF instance is an instance of a producer NF that provides a service. A given producer NF may include more than one NF instance. It should also be noted that multiple NF instances can share the same service endpoint.

NFs register with a network function repository function (NRF). The NRF maintains profiles of available NF instances identifying the services supported by each NF instance. The profile of an NF instance is referred to in 3GPP TS 29.510 as an NF profile. NF instances can obtain information about other NF instances that have registered with the NRF through the NF discovery service operation. According to the NF discovery service operation, a consumer NF sends an NF discovery request to the NRF. The NF discovery request includes query parameters that the NRF uses to locate the NF profiles of producer NFs capable of providing the service identified by the query parameters. NF profiles are data structures that define the type of service provided by an NF instance as well as contact and capacity information regarding the NF instance.

An SCP can also invoke the NF discovery service operation to learn about available producer NF instances. The case where the SCP uses the NF discovery service operation to obtain information about producer NF instances on behalf of consumer NFs is referred to as delegated discovery. Consumer NFs connect to the SCP, and the SCP load balances traffic among producer NF service instances that provide the required services or directly routes the traffic to the destination producer NF instances.

One problem that can occur in 5G and subsequent generation networks relates to forwarding inter-PLMN messages to unavailable producer SEPPs or P-SEPPs using information provided in domain name system (DNS) service (SRV) records. DNS SRV records specify host, port, priority, and weight information for servers that provide a given service. For inter-PLMN SBI request messages, the DNS SRV record may include host information for P-SEPPs that allow access to a network. To forward a message to another PLMN, a consumer SEPP or C-SEPP queries a DNS server using an FQDN obtained or constructed from the message. The DNS server returns a DNS SRV record identifying P-SEPPs that can be used to access a target network. The C-SEPP selects one of the P-SEPPs identified in the DNS SRV and forwards the message to the selected P-SEPP.

A problem that can occur is that the selected P-SEPP may be unavailable, even though it is listed as one of the target P-SEPPs in the DNS SRV record. The reason that a DNS SRV record may include information for an unavailable P-SEPP is that monitoring P-SEPP availability status and updating DNS SRV records to remove data for unavailable P-SEPPs is burdensome on network operators. As a result, the DNS SRV records returned in response to a DNS query from the C-SEPP may include data for unavailable P-SEPPs. The receiving C-SEPP may forward the inter-PLMN SBI request message to an unavailable P-SEPP, fail to receive a response within a timeout period, and retry sending the inter-PLMN message to another P-SEPP identified in the DNS SRV record. The process is repeated until the C-SEPP receives a valid response to the SBI request message. Reliance on DNS SRV records alone to select P-SEPPs for inter-PLMN SBI request messages thus results in unnecessary increases in network traffic and places a burden on the resources of the C-SEPP.

Accordingly, in light of these and other difficulties, there exists a need for improved methods, systems, and computer readable media for forwarding inter-PLMN SBI request messages to available P-SEPPs.

### SUMMARY

A method for forwarding inter-public land mobile network (PLMN) service-based interface (SBI) request messages to available producer security edge protection proxies (P-SEPPs) includes establishing, by a consumer SEPP (C-SEPP), connections with a plurality of P-SEPPs. The method further includes testing, by the C-SEPP, availability status of each of the P-SEPPs. The method further includes maintaining, by the C-SEPP and based on the testing, an indication of availability status of each of the P-SEPPs. The method further includes receiving, by the C-SEPP, an inter-PLMN SBI request message and determining, from the message, a fully qualified domain name (FQDN). The method further includes resolving the FQDN into a domain name system (DNS) SRV record including target identifiers corresponding to the P-SEPPs. The method further includes selecting one of the target identifiers in the DNS SRV record corresponding to one of the P-SEPPs having an available status. The method further includes forwarding the message to the P-SEPP corresponding to the selected target identifier.

According to another aspect of the subject matter described herein, establishing connections with the P-SEPPs includes establishing N32-c connections with the P-SEPPs.

According to another aspect of the subject matter described herein, testing availability status of the P-SEPPs includes transmitting an availability status check request message to each of the P-SEPPs to the P-SEPPs and determining whether a response to the availability status check request message is received for each of the P-SEPPs within a timeout period.

According to another aspect of the subject matter described herein, transmitting an availability status check request message to each of the P-SEPPs includes transmitting an N32-c handshake message to each of the P-SEPPs.

According to another aspect of the subject matter described herein, transmitting an availability status check request message to each of the P-SEPPs includes transmitting a packet internet groper (PING) message to each of the P-SEPPs.

According to another aspect of the subject matter described herein, transmitting an availability status check request message to each of the P-SEPPs includes transmitting a hypertext transfer protocol (HTTP) OPTIONS message to each of the available P-SEPPs.

According to another aspect of the subject matter described herein, maintaining indications of the availability status of each of the P-SEPPs includes storing, in a P-SEPP availability status database, the indications of availability status of each of the P-SEPPs.

According to another aspect of the subject matter described herein, resolving the FQDN into the DNS SRV record includes querying a DNS server using the FQDN as a query parameter and receiving a response from the DNS server including the DNS SRV record.

According to another aspect of the subject matter described herein, selecting one of the target identifiers comprises selecting the one target identifier based on priority and weight parameter values in the DNS SRV record.

According to another aspect of the subject matter described herein, the method for forwarding inter-PLMN SBI request messages to available P-SEPPs includes distributing a weight parameter value of an unavailable P-SEPP identified in the DNS SRV record among available P-SEPPs identified in the DNS SRV record to generate adjusted weight parameter values for the available P-SEPPs identified in the DNS SRV record.

According to another aspect of the subject matter described herein, a system for forwarding inter-public land mobile network (PLMN) service-based interface (SBI) request messages to available producer security edge protection proxies (P-SEPPs) is provided. The system includes a SEPP including at least one processor and a memory. The system further includes an N32 egress gateway implemented by the at least one processor for establishing connections with a plurality of P-SEPPs. The system further includes an availability status check monitor implemented by the at least one processor for testing availability status of each of the P-SEPPs and maintaining, based on the testing, an indication of availability status of each of the P-SEPPs. The system further includes an alternate route service implemented by the at least one processor for receiving an inter-PLMN SBI request message, determining, from the message, a fully qualified domain name (FQDN), and resolving the FQDN into a domain name system (DNS) SRV record including target identifiers corresponding to the P-SEPPs, where the N32 egress gateway is configured to select one of the target identifiers in the DNS SRV record corresponding to one of the P-SEPPs having an available status and forward the message to the P-SEPP corresponding to the selected target identifier.

According to another aspect of the subject matter described herein, the connections comprise N32-c connections.

According to another aspect of the subject matter described herein, the N32 egress gateway is configured to test the availability status of the available P-SEPPs by transmitting an availability status check request message to each of the P-SEPPs and determining whether a response to the availability status check request message is received for each of the P-SEPPs within a timeout period.

According to another aspect of the subject matter described herein, the availability status check request message comprises an N32-c handshake message.

According to another aspect of the subject matter described herein, the availability status check request message includes a packet internet groper (PING) message.

According to another aspect of the subject matter described herein, the availability status check request comprises a hypertext transfer protocol (HTTP) OPTIONs message.

According to another aspect of the subject matter described herein, in maintaining indications of the availability status of each of the P-SEPPs, the availability status check monitor is configured to store, in a P-SEPP availability status database, the indications of availability status of each of the P-SEPPs.

According to another aspect of the subject matter described herein, in resolving the FQDN into the DNS SRV record, the alternate route service is configured to query a DNS server using the FQDN as a query parameter and receive a response from the DNS server including the DNS SRV record.

According to another aspect of the subject matter described herein, the N32 egress gateway is configured to select the one target identifier based on priority and weight parameter values in the DNS SRV record.

According to another aspect of the subject matter described herein, a non-transitory computer readable medium having stored thereon executable instructions that when executed by a processor of a computer control the computer to perform steps is provided. The steps include establishing, by a consumer security edge protection proxy (C-SEPP), connections with a plurality of producer SEPPs (P-SEPPs). The steps further include testing, by the C-SEPP, availability status of each of the P-SEPPs. The steps further include maintaining, by the C-SEPP and based on the testing, an indication of availability status of each of the P-SEPPs. The steps further include receiving, by the C-SEPP, an inter-public land mobile network (PLMN) service-based interface (SBI) request message and determining, from the message, a fully qualified domain name (FQDN). The steps further include resolving the FQDN into a domain name system (DNS) SRV record including target identifiers corresponding to the P-SEPPs. The steps further include selecting one of the target identifiers in the DNS SRV record corresponding to one of the P-SEPPs having an available status. The steps further include forwarding the message to the P-SEPP corresponding to the selected target identifier.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a network diagram illustrating an exemplary 5G system network architecture;

FIG. 2 is a network diagram illustrating a problem that can occur when relying on DNS SRV records alone to forward inter-PLMN SBI request messages;

FIG. 3 is a network diagram illustrating the tracking of P-SEPP availability information and using the P-SEPP availability information in combination with DNS SRV records to forward inter-PLMN SBI request messages to available P-SEPPs;

FIG. 4 is a message flow diagram illustrating the tracking of P-SEPP availability information and the use of the P-SEPP availability information in combination with DNS SRV records to forward inter-PLMN SBI request messages to available P-SEPPs;

FIG. 5 is a message flow diagram illustrating exemplary messages exchanged in tracking P-SEPP availability information;

FIG. 6 is a block diagram illustrating an exemplary architecture of a SEPP for tracking and using P-SEPP availability information to forward inter-PLMN SBI request messages to available P-SEPPs; and

FIG. 7 is a flow chart illustrating an exemplary process for tracking and using P-SEPP availability information to forward inter-PLMN SBI request messages to available P-SEPPs.

### DETAILED DESCRIPTION

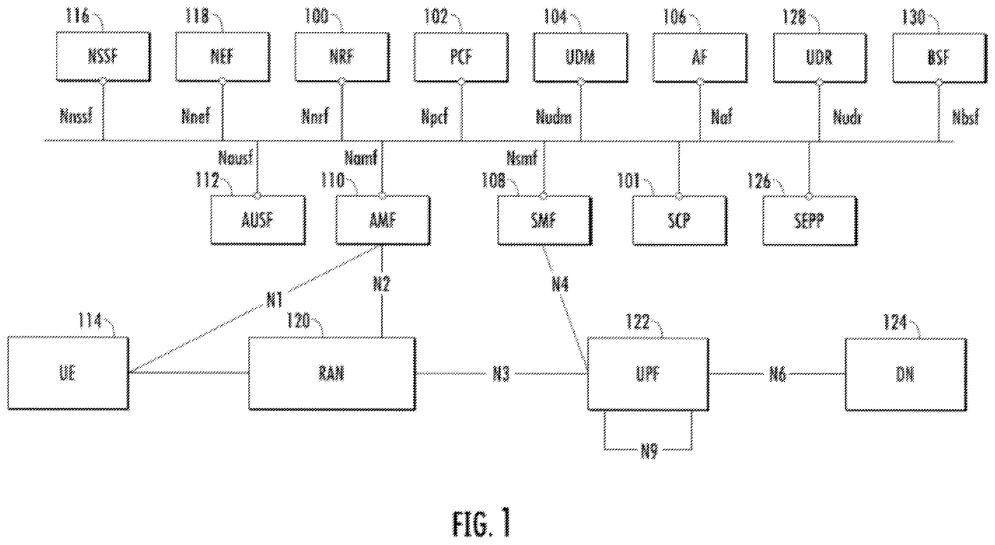

FIG. 1 is a block diagram illustrating an exemplary 5G system network architecture. The architecture in FIG. 1 includes NRF 100 and SCP 101, which may be located in the same home public land mobile network (HPLMN). As described above, NRF 100 may maintain profiles of available NF instances and their supported services and allow consumer NFs or SCPs to subscribe to and be notified of the registration of new/updated NF instances. SCP 101 may also support service discovery and selection of NF instances. SCP 101 may perform load balancing of connections between consumer and producer NFs.

NRF 100 is a repository for profiles of NF instances. To communicate with a producer NF instance, a consumer NF or an SCP must obtain the NF profile of the producer NF instance from NRF 100. The NF profile is a JavaScript object notation (JSON) data structure defined in 3GPP TS 29.510. The NF profile includes attributes that indicate the type of service provided, capacity of the NF instance, and information for contacting the NF instance.

In FIG. 1, any of the network functions can be consumer NFs, producer NFs, or both, depending on whether they are requesting, providing, or requesting and providing services. In the illustrated example, the NFs include a policy control function (PCF) 102 that performs policy related operations in a network, a unified data management function (UDM) 104 that manages user data, and an application function (AF) 106 that provides application services.

The NFs illustrated in FIG. 1 further include a session management function (SMF) 108 that manages sessions between an access and mobility management function (AMF) 110 and PCF 102. AMF 110 performs mobility management operations similar to those performed by a mobility management entity (MME) in 4G networks. An authentication server function (AUSF) 112 performs authentication services for user equipment (UEs), such as user equipment (UE) 114, seeking access to the network.

A network slice selection function (NSSF) 116 provides network slicing services for devices seeking to access specific network capabilities and characteristics associated with a network slice. NSSF 116 provides the NSSelection service, which allows NFs to request information about network slices and the NSSAIReachability service, which enables NFs to update and subscribe to receive notification of updates in network slice selection assistance information (NSSAI) reachability information.

A network exposure function (NEF) 118 provides application programming interfaces (APIs) for application functions seeking to obtain information about Internet of things (IoT) devices and other UEs attached to the network. NEF 118 performs similar functions to the service capability exposure function (SCEF) in 4G networks.

A radio access network (RAN) 120 connects user equipment (UE) 114 to the network via a wireless link. Radio access network 120 may be accessed using a gNB (not shown in FIG. 1) or other wireless access point. A user plane function (UPF) 122 can support various proxy functionality for user plane services. One example of such proxy functionality is multipath transmission control protocol (MPTCP) proxy functionality. UPF 122 may also support performance measurement functionality, which may be used by UE 114 to obtain network performance measurements. Also illustrated in FIG. 1 is a data network (DN) 124 through which UEs access data network services, such as Internet services.

A SEPP 126 filters incoming traffic from another PLMN and can perform topology hiding for traffic exiting the home PLMN. SEPP 126 may communicate with a SEPP in a foreign PLMN which manages security for the foreign PLMN. Thus, traffic between NFs in different PLMNs may traverse two SEPP functions, one for the home PLMN and the other for the foreign PLMN. A SEPP filtering egress messages from consumer NFs in a PLMN is referred to a consumer SEPP or C-SEPP. A SEPP that filters ingress messages directed to consumer NFs in a PLMN is referred to as a producer SEPP or P-SEPP. A given SEPP can function as a C-SEPP and a P-SEPP, depending on the role the SEPP is performing.

A unified data repository (UDR) 128 stores subscription data for UEs. A binding support function (BSF) 130 manages bindings between PDU sessions and PCFs.

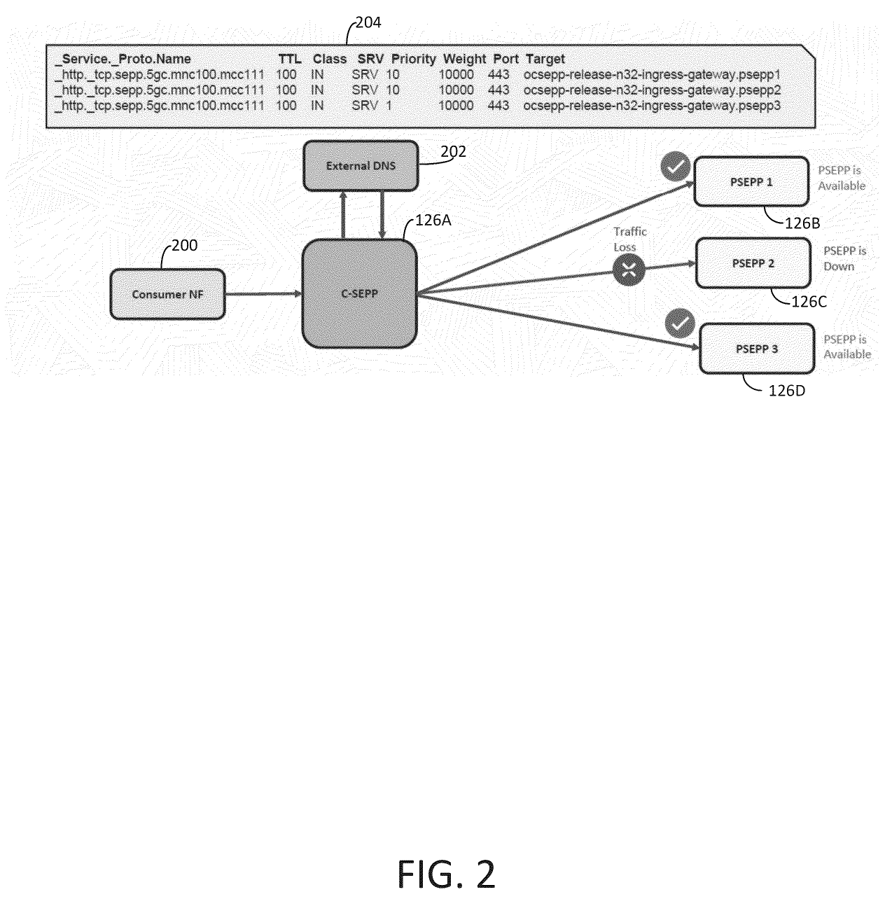

As described above, one problem that can occur in 5G and subsequent generation networks is that DNS SRV records may contain data for unavailable P-SEPPs, and C-SEPPs may, in reliance on the data in the DNS SRV records, forward messages to unavailable P-SEPPs. FIG. 2 is a network diagram illustrating a problem that can occur when relying on DNS SRV records alone to forward inter-PLMN SBI request messages. Referring to FIG. 2, a consumer NF 200 seeks to transmit an inter-PLMN SBI request message via C-SEPP 126A to one of P-SEPPs 126B, 126C, and 126D. Consumer NF 200 transmits the SBI request to C-SEPP 126A. C-SEPP 126A receives the SBI request and queries a DNS server 202 with a target FQDN obtained or constructed from parameters in the inter-PLMN SBI request message. DNS server 202 performs a lookup in its database using the FQDN and returns SRV record 204. SRV record 204 includes the following data for each of P-SEPPs 126B, 126C, and 126D:
1. A_Service._Proto.name field, which contains an identifier for the type of service, the transport layer protocol, and the domain name of the host providing the service. In DNS SRV record 204, the first_Service._Proto. Name attribute identifies HTTP as the service type, TCP as the transport layer protocol, and sepp.5gc.mnc100.mcc111 as the domain name of the host providing the SEPP service;
2. A time to live (TTL) field, which defines a time after which the DNS SRV record needs to be refreshed;
3. A class field, which stores an indicator of the class of each target server identified in the DNS SRV record;
4. An SRV field, which defines the DNS record type as SRV;
5. A priority field, which defines the relative priority of each target server identified in the DNS SRV record;
6. A weight field, which stores a weight value used for load sharing;
7. A port field, which stores a value indicating the transport layer port used by each target server; and
8. A target field, which identifies the target server for each entry in the DNS SRV record.

In the illustrated example, DNS SRV record 204 includes a target field identifying servers corresponding to each of P-SEPPs 126B, 126C, and 126D. However, P-SEPP 126C is unavailable. Accordingly, when C-SEPP 126A relies solely on the data provided by DNS SRV record 204, C-SEPP 126A will forward some messages to unavailable P-SEPP 126C. Messages forwarded to unavailable P-SEPP 126C will be lost, requiring selection of another P-SEPP and retransmission by C-SEPP 126A, which is undesirable, as such retransmission wastes network bandwidth and the processing resources of C-SEPP 126A.

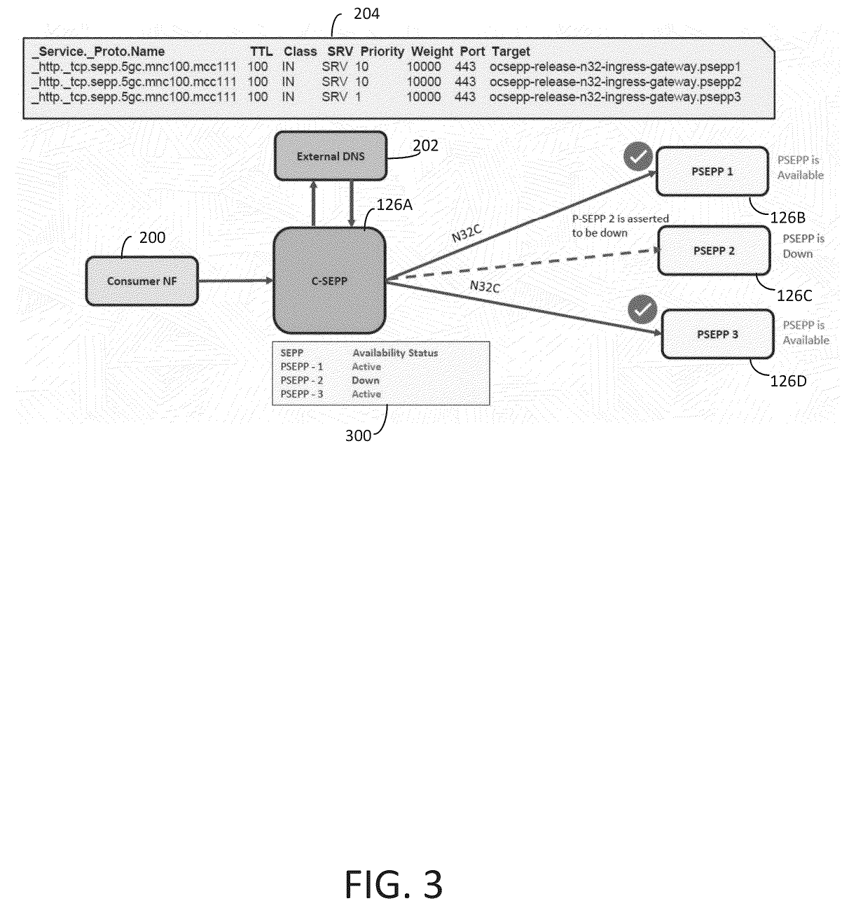

To reduce the likelihood of the scenario illustrated in FIG. 2, a C-SEPP may track availability status of P-SEPPs and use the availability status to avoid sending messages to an unavailable P-SEPP identified in a DNS SRV record. FIG. 3 is a network diagram illustrating the tracking of P-SEPP availability information and using the P-SEPP availability information in combination with DNS SRV records to forward inter-PLMN SBI request messages to available P-SEPPs. In FIG. 3, C-SEPP 126A establishes N32-c connections with each of P-SEPPs 126B, 126C, and 126D. After establishing the N32-c connections, P-SEPP 126C becomes unavailable. C-SEPP 126A periodically tests the availability status of each of P-SEPPs 126B, 126C, and 126D and maintains, in memory accessible by C-SEPP 126A, a P-SEPP availability status database 300 that stores indications of availability status of each of P-SEPPs 126B, 126C, and 126D. When C-SEPP 126A receives an inter-PLMN SBI request message from consumer NF 200, C-SEPP 126A resolves the target FQDN determined from the message by querying DNS server 202 and obtaining DNS SRV record 204. C-SEPP 126A checks the P-SEPP availability status information maintained in database 300 for the P-SEPPs identified in DNS SRV record 204 and removes, as selection candidates for the SBI request message, any P-SEPPs for which the availability status indicates that the P-SEPP is unavailable. C-SEPP 126A may redistribute the weight parameter value of the unavailable P-SEPP among the available P-SEPPs in proportion to their current weights. For example, if an unavailable P-SEPP has a weight of 1000 and the DNS SRV record indicates two peer P-SEPPs at the same priority level with weights of 1000 and 500, C-SEPP 126A may increase the weights of the two peer P-SEPPs to 1667 and 833, respectively. C-SEPP 126A may then use the priority and weight values of available P-SEPPs to select a P-SEPP for the SBI request message and may forward the message to the selected P-SEPP.

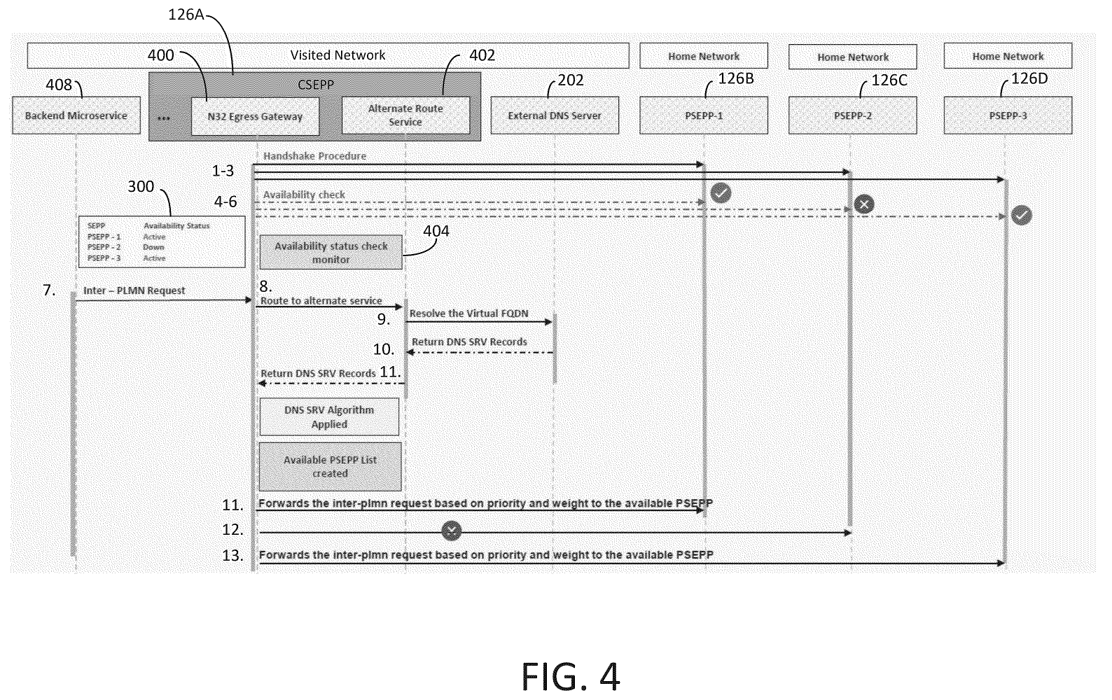

FIG. 4 is a message flow diagram illustrating the tracking of P-SEPP availability information and using the P-SEPP availability information in combination with DNS SRV records to forward inter-PLMN SBI request messages to available P-SEPPs. In FIG. 4, C-SEPP 126A includes an N32 egress gateway 400 that establishes N32 connections with other SEPPs and forwards inter-PLMN SBI request messages to available P-SEPPs. C-SEPP 126A also includes an alternate route service 402 that resolves FQDNs using DNS server 202. C-SEPP 126A further includes an availability status check monitor 404 that checks and maintains availability status information for peer P-SEPPs.

Referring to the message flow illustrated in FIG. 4, in steps 1-3, N32 egress gateway 400 of C-SEPP 126A conducts an N32 handshake procedure with each of P-SEPPs 126B, 126C, and 126D and establishes N32-c connections with each of P-SEPPs 126B, 126C, and 126D. After the N32-c connections are established, P-SEPP 126C becomes unavailable, for example, due to an outage of P-SEPP 126C, network congestion, or any other reason that would make P-SEPP 126C unable to receive and forward SBI request messages. In steps 4-6, availability status check monitor 404 of C-SEPP 126A performs availability status checks of each of P-SEPPs 126B, 126C, and 126D, and determines that P-SEPP 126C is unavailable. Availability status check monitor 404 performs the status checks by transmitting an availability status check message to each of P-SEPPs 126B, 126C, and 126D and determining that a message timeout occurs with respect to the message transmitted to P-SEPP 126C. Examples of messages that may be used for the availability status checks include N32 handshake requests, hypertext transfer protocol (HTTP) OPTIONs requests, packet internet groper (PING) messages, or custom messages. After performing the availability status check, availability status check monitor 404 stores indications of the availability status of each of P-SEPPs 126B, 126C, and 126D in P-SEPP availability status database 300.

In step 7, a consumer NF 408 sends an inter-PLMN SBI request message to C-SEPP 126A. N32 egress gateway 400 of C-SEPP 126A receives the request and in step 8, sends an internal message to alternate route service 402 to resolve the FQDN determined from the SBI request message. The FQDN is of the format:
<prefix>0.5g.mcc<MCC>.mnc<MNC>0.3gppnetwork.org.
   The mobile country code (MCC) and mobile network code (MNC) are retrieved from the 3gpp-sbi-target-apiRoot header of the inter-PLMN SBI Request message. The combination of the MNC and MCC is used to construct the FQDN. The <prefix> attribute in the FQDN is set to “sepp” so that C-SEPP 126A can obtain the DNS SRV record for the SEPPs used to access the target network. In FIG. 4, the constructed FQDN is a virtual FQDN, which is tied to a pool of common NFs (in this case SEPPs) in DNS.

In step 9, alternate route service 402 queries DNS server 202 for the SRV record for the requested service. In step 9, DNS server 202 returns the SRV record to alternate route service 402. Alternate route service 402 transmits the SRV record to N32 egress gateway 400. In step 10, N32 egress gateway 400 applies the DNS SRV algorithm to select a target P-SEPP from the P-SEPPs identified in the DNS SRV record that are indicated as available based on the availability status information. In performing the selection, N32 egress gateway 400 may distribute the weight assigned to unavailable P-SEPPs among available P-SEPPs. In step 11, N32 egress gateway 400 forwards the inter-PLMN SBI request to P-SEPP 126B, which was selected based on the priority and weight parameters in the DNS SRV record. The forwarding of inter-PLMN SBI request messages to unavailable P-SEPP 126C indicated in step 12 is avoided. Messages can also be sent to available P-SEPP 126D based on priority and weight, as indicated by step 13.

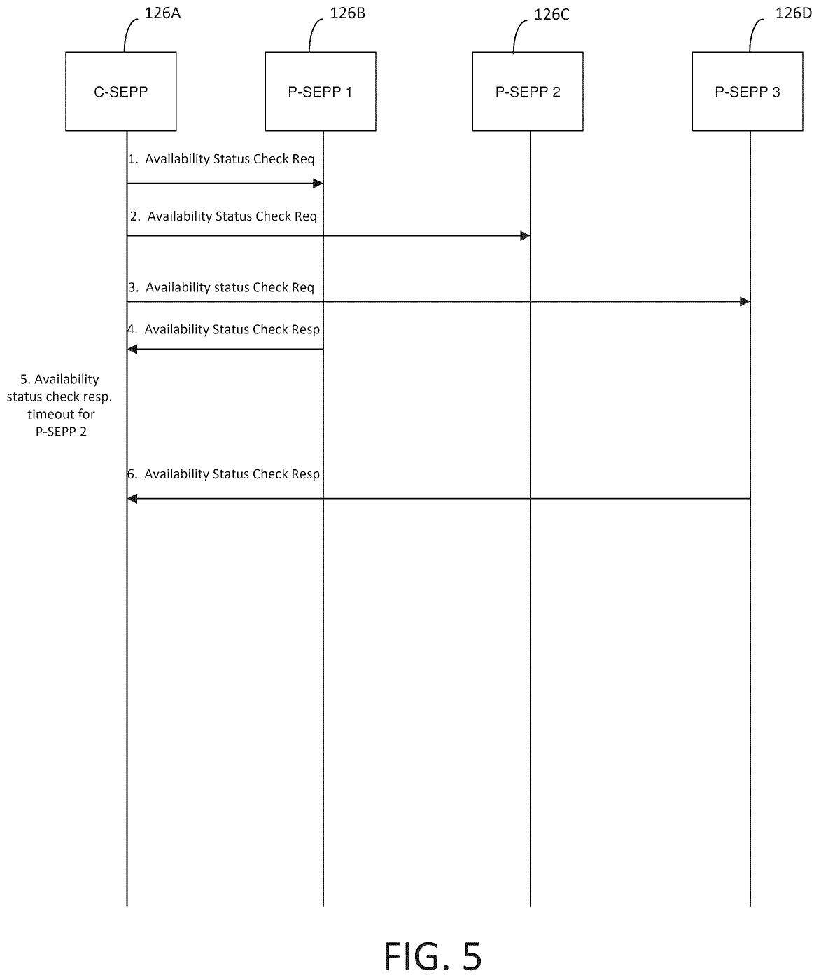

FIG. 5 is a message flow diagram illustrating exemplary messages exchanged in tracking P-SEPP availability information. Referring to FIG. 5, in steps 1-3, C-SEPP 126A sends an availability status check request message to each of P-SEPPs 126B, 126C, and 126D. The availability status check request messages may be any suitable messages that require a response from P-SEPPs 126B, 126C, and 126D. In one example, the availability status check request messages may be N32 handshake messages, such as N32 security capability exchange request messages. According to 3GPP TS 29.573, an initiating SEPP invokes the security capability negotiation procedure by sending an HTTP POST message to the responding SEPP with the SecNegotiateReqData information element carrying security capability information. The responding SEPP responds with either a 200 OK message carrying security attributes, a 4xx or 5xx message with problem details, or a 3xx message indicating redirection. When C-SEPP 126A sends the HTTP POST message, C-SEPP 126A starts a response timer. If the response timer reaches a predetermined value before one of the acceptable responses is received, C-SEPP 126A determines that a response timeout has occurred and stores an indication that the P-SEPP to which the HTTP POST message was sent is unavailable.

In another example, the availability check request messages may be messages associated with the PING service, such as Internet control message protocol (ICMP) echo request messages. According to IETF RFC 792, the expected response to an echo request message is an echo response message. When C-SEPP 126A sends an ICMP echo request message to a P-SEPP, C-SEPP 126A starts a response timer. If C-SEPP 126A detects that the timer reaches a predetermined value before receiving an ICMP echo response message, C-SEPP 126A will determine that a response timeout has occurred and will store an indication in P-SEPP availability status database 300 that the P-SEPP being tested is unavailable.

In yet another examples, the availability status messages may be HTTP OPTIONS messages. According to IETF RFC 7231, an HTTP OPTIONS request is a request to determine communications options for the target resource. The expected response is a 200 OK message. When C-SEPP 126A sends an HTTP OPTIONs message to a P-SEPP, C-SEPP 126A starts a response timer. If C-SEPP 126A detects that the timer reaches a predetermined value before receiving a response message, C-SEPP 126A will determine that a response timeout has occurred and will store an indication in P-SEPP availability status database 300 that the P-SEPP being tested is unavailable.

In steps 4 and 6, C-SEPP 126A receives availability check responses from P-SEPPs 126B and 126D. However, a response timeout occurs with respect to the availability check request message sent to P-SEPP 126C. Accordingly, in step 5, C-SEPP 126A detects the response timeout for P-SEPP 126C and stores an indication in P-SEPP availability status database 300 that P-SEPP 126C is unavailable. The steps illustrated in FIG. 5 may be performed continually, e.g., periodically or aperiodically, to maintain current availability information for P-SEPPs 126B, 126C, and 126D in P-SEPP availability status database 300.

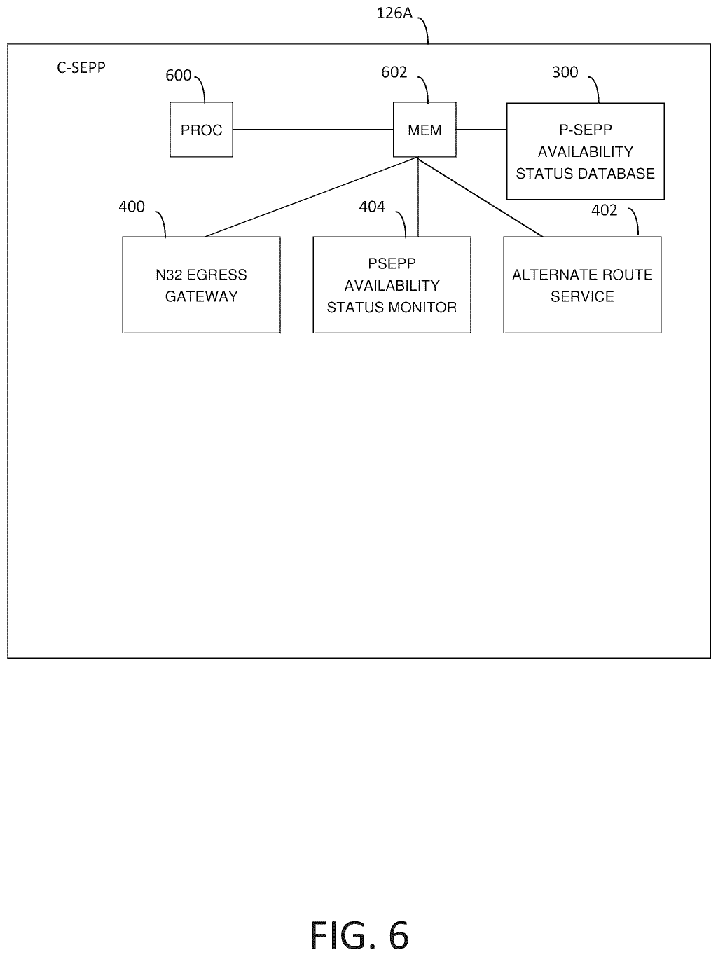

FIG. 6 is a block diagram illustrating an exemplary architecture of a SEPP for tracking and using P-SEPP availability information to forward inter-PLMN SBI request messages to available P-SEPPs. In FIG. 6, C-SEPP 126A includes at least one processor 600 and memory 602. C-SEPP 126A includes P-SEPP availability status database 300, which stores indications of the current status of peer P-SEPPs. C-SEPP 126A further includes N32 egress gateway 400, P-SEPP availability status check monitor 404, and alternate route service 402. N32 egress gateway 400 performs the steps described above with regard to FIG. 4 of conducting the N32 handshake procedure with peer P-SEPPs and forwarding inter-PLMN SBI request messages to available peer P-SEPPs. Alternate route service 402 queries DNS server 202 to resolve FQDNs for inter-PLMN SBI request messages. P-SEPP availability status check monitor 404 performs the steps described above of monitoring the availability status of peer P-SEPPs and storing indications of the availability status in P-SEPP availability status database 300. N32 egress gateway 400, alternate route service 402, and P-SEPP availability status check monitor 404 may be implemented using computer executable instructions stored in memory 602 and executed by processor 600.

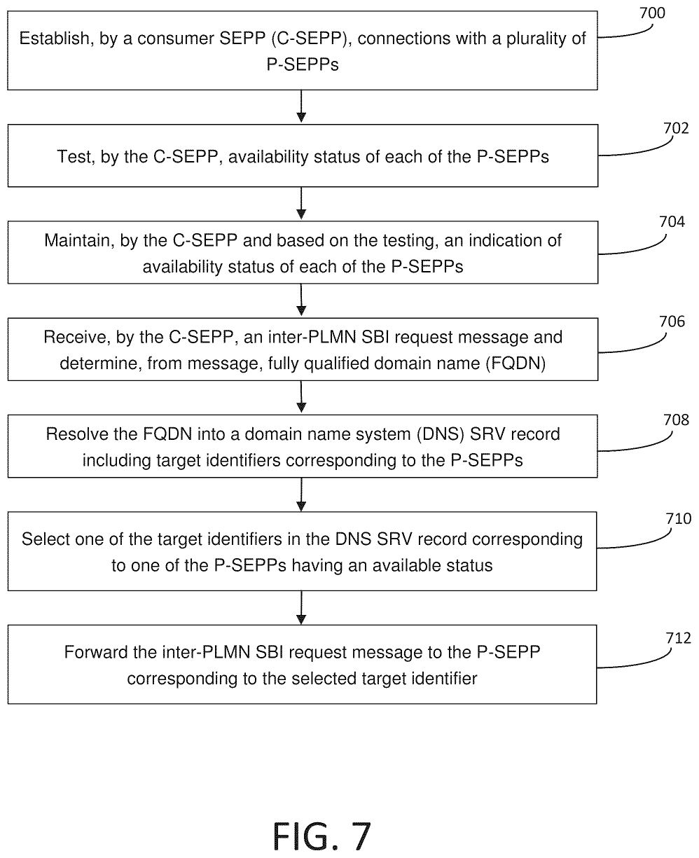

FIG. 7 is a flow chart illustrating an exemplary process for tracking and using P-SEPP availability information to forward inter-PLMN SBI request messages to available P-SEPPs. Referring to FIG. 7, in step 700, the process includes establishing, by a C-SEPP, connections with a plurality of P-SEPPs. For example, C-SEPP 126A may establish N32 connections with P-SEPPs 126B, 126C, and 126D that are configured with C-SEPP 126A as peer P-SEPPs. The N32 connections may be established according to the N32 handshake procedure as described in 3GPP TS 29.573.

In step 702, the process includes testing, by the C-SEPP, availability status of each of the P-SEPPs. For example, C-SEPP 126A may send availability status check request messages to each of its peer P-SEPPs, start a message timeout timer for each request, and determine whether valid responses are received before the timers expire.

In step 704, the process includes maintaining, by the C-SEPP and based on the testing, an indication of availability status of each of the P-SEPPs. For example, C-SEPP 126A may, for each availability status check message for which a message timeout occurred, store an indication in P-SEPP availability status database 300 that the P-SEPP is unavailable.

In step 706, the process includes receiving, by the C-SEPP, an inter-PLMN SBI request message and determining, from the message, an FQDN. As described above, the FQDN can be constructed from the MCC and MNC obtained from the 3gpp-Sbi-Target-apiRoot header of the inter-PLMN SBI request message. An example of an FQDN that can be constructed in this manner is sepp.5g.mcc1234.mnc5678.3gppnetwork.org, where 1234 is the MNC and 5678 is the MCC obtained from the 3gpp-Sbi-Target-apiRoot header of the message.

In step 708, the process includes resolving the FQDN into a DNS SRV record including target identifiers corresponding to the P-SEPPs. For example, C-SEPP 126A may query DNS server 202 using the FQDN determined in step 706 and receive, in a DNS response from DNS server 202, a DNS SRV record containing entries for P-SEPPs, where each entry includes a target P-SEPP identifier, a weight value, and a priority value.

In step 710, the process includes selecting one of the target identifiers in the DNS SRV record corresponding to one of the P-SEPPs having an available status. For example, C-SEPP 126A may access P-SEPP availability status database 300 to determine whether the P-SEPPs identified in the DNS SRV record are available. If all of the P-SEPPs are available, C-SEPP 126A may select from the P-SEPPs in the DNS SRV record based on priority and weight attribute values. If any of the P-SEPPs are not available, C-SEPP 126A may exclude the unavailable P-SEPPs from the selection process and select from the available P-SEPPs based on the priority and weight attribute values. In one example, as described above, C-SEPP 126A may distribute the weight values of unavailable P-SEPPs among the available P-SEPPs and perform the selection using the adjusted weight values.

In step 712, the process includes forwarding the inter-PLMN SBI request message to the P-SEPP corresponding to the selected target identifier. For example, C-SEPP 126A may forward the inter-PLMN SBI request message to the P-SEPP selected in step 710.

Exemplary advantages of the subject matter described herein include a reduction in unnecessary inter-PLMN SBI request message traffic caused by retransmissions when a message is initially forwarded to an unavailable P-SEPP. C-SEPP processing resources are conserved by avoiding inter-PLMN SBI request message retransmissions.

The subject matter described herein can be implemented at a hosted SEPP, a non-hosted SEPP, or a SEPP that functions as a roaming hub. A hosted SEPP is a SEPP hosted by an IP exchange (IPX) provider. A non-hosted SEPP is a SEPP operated by the same network operator that operates the PLMN. A roaming hub is an interconnection platform used to connect different mobile networks and is operated by a roaming hub provider.

The disclosure of each of the following references is hereby incorporated herein by reference in its entirety.

### REFERENCES

1. 3^{rd} Generation Partnership Project; Technical Specification Group Core Network and Terminals; 5G System; Network Function Repository Services; Stage 3 (Release 18) 3GPP TS 29.510 V18.5.0 (2023-12)
2. 3^{rd} Generation Partnership Project; Technical Specification Group Services and System Aspects; Security architecture and procedures for the 5G System; Stage 2 (Release 18) 3GPP TS 33.501 V18.4.0 (2023-12)
3. 3^{rd} Generation Partnership Project; Technical Specification Group Core Network and Terminals; 5G System; Public Land Mobile Network (PLMN) Interconnection; Stage 3 (Release 18) 3GPP TS 29.573 V18.5.0 (2023-12)
4. Postel, J., “DARPA Internet Program Protocol Specification”, IETF RFC 792 (September 1981)
5. Feilding, R. and Reschke, J., “Hypertext Transfer Protocol (HTTP/1.1): Semantics and Content,” IETF RFC 7231 (June 2014)

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for forwarding inter-public land mobile network (PLMN) service-based interface (SBI) request messages to available producer security edge protection proxies (P-SEPPs), the method comprising:
establishing, by a consumer SEPP (C-SEPP), connections with a plurality of P-SEPPs;
testing, by the C-SEPP, availability status of each of the P-SEPPs;
maintaining, by the C-SEPP and based on the testing, an indication of availability status of each of the P-SEPPs;
receiving, by the C-SEPP, an inter-PLMN SBI request message and determining, from the message, a fully qualified domain name (FQDN);
resolving the FQDN into a domain name system (DNS) service (SRV) record including target identifiers corresponding to the P-SEPPs;
selecting one of the target identifiers in the DNS SRV record corresponding to one of the P-SEPPs having an available status; and
forwarding the message to the P-SEPP corresponding to the selected target identifier.

2. The method of claim 1 wherein establishing connections with the P-SEPPs includes establishing N32-c connections with the P-SEPPs.

3. The method of claim 2 wherein testing availability status of the P-SEPPs includes transmitting an availability status check request message to each of the P-SEPPs to the P-SEPPs and determining whether a response to the availability status check request message is received for each of the P-SEPPs within a timeout period.

4. The method of claim 3 wherein transmitting an availability status check request message to each of the P-SEPPs includes transmitting an N32-c handshake message to each of the P-SEPPs.

5. The method of claim 3 wherein transmitting an availability status check request message to each of the P-SEPPs includes transmitting a packet internet groper (PING) message to each of the P-SEPPs.

6. The method of claim 3 wherein transmitting an availability status check request message to each of the P-SEPPs includes transmitting a hypertext transfer protocol (HTTP) OPTIONs message to each of the available P-SEPPs.

7. The method of claim 1 wherein maintaining indications of the availability status of each of the P-SEPPs includes storing, in a P-SEPP availability status database, the indications of availability status of each of the P-SEPPs.

8. The method of claim 1 wherein resolving the FQDN into the DNS SRV record includes querying a DNS server using the FQDN as a query parameter and receiving a response from the DNS server including the DNS SRV record.

9. The method of claim 1 wherein selecting one of the target identifiers comprises selecting the one target identifier based on priority and weight parameter values in the DNS SRV record.

10. The method of claim 9 comprising distributing a weight parameter value of an unavailable P-SEPP identified in the DNS SRV record among available P-SEPPs identified in the DNS SRV record to generate adjusted weight parameter values for the available P-SEPPs identified in the DNS SRV record.

11. A system for forwarding inter-public land mobile network (PLMN) service-based interface (SBI) request messages to available producer security edge protection proxies (P-SEPPs), the system comprising:
a SEPP including at least one processor and a memory;
an N32 egress gateway implemented by the at least one processor for establishing connections with a plurality of P-SEPPs;
an availability status check monitor implemented by the at least one processor for testing availability status of each of the P-SEPPs and maintaining, based on the testing, an indication of availability status of each of the P-SEPPs; and
an alternate route service implemented by the at least one processor for receiving an inter-PLMN SBI request message, determining, from the message, a fully qualified domain name (FQDN), and resolving the FQDN into a domain name system (DNS) service (SRV) record including target identifiers corresponding to the P-SEPPs, wherein the N32 egress gateway is configured to select one of the target identifiers in the DNS SRV record corresponding to one of the P-SEPPs having an available status and forward the message to the P-SEPP corresponding to the selected target identifier.

12. The system of claim 11 wherein the connections comprise N32-c connections.

13. The system of claim 12 wherein the N32 egress gateway is configured to test the availability status of the available P-SEPPs by transmitting an availability status check request message to each of the P-SEPPs and determining whether a response to the availability status check request message is received for each of the P-SEPPs within a timeout period.

14. The system of claim 13 wherein the availability status check request message comprises an N32-c handshake message.

15. The system of claim 13 wherein the availability status check request message includes a packet internet groper (PING) message.

16. The system of claim 13 wherein the availability status check request comprises a hypertext transfer protocol (HTTP) OPTIONs message.

17. The system of claim 11 wherein, in maintaining indications of the availability status of each of the P-SEPPs, the availability status check monitor is configured to store, in a P-SEPP availability status database, the indications of availability status of each of the P-SEPPs.

18. The system of claim 11 wherein, in resolving the FQDN into the DNS SRV record, the alternate route service is configured to query a DNS server using the FQDN as a query parameter and receive a response from the DNS server including the DNS SRV record.

19. The system of claim 11 wherein N32 egress gateway is configured to select the one target identifier based on priority and weight parameter values in the DNS SRV record.

20. A non-transitory computer readable medium having stored thereon executable instructions that when executed by a processor of a computer control the computer to perform steps comprising:
establishing, by a consumer security edge protection proxy (C-SEPP), connections with a plurality of producer SEPPs (P-SEPPs);
testing, by the C-SEPP, availability status of each of the P-SEPPs;
maintaining, by the C-SEPP and based on the testing, an indication of availability status of each of the P-SEPPs;
receiving, by the C-SEPP, an inter-public land mobile network (PLMN) service-based interface (SBI) request message and determining, from the message, a fully qualified domain name (FQDN);
resolving the FQDN into a domain name system (DNS) service (SRV) record including target identifiers corresponding to the P-SEPPs;
selecting one of the target identifiers in the DNS SRV record corresponding to one of the P-SEPPs having an available status; and
forwarding the message to the P-SEPP corresponding to the selected target identifier.
